(19) United States
(12) Patent Application Publication
(10) Pub. No.: US 2026/0318391 A1
(43) Pub. Date: Oct. 15, 2026

(54) ENDURANCE TESTING APPARATUS

(71) Applicant: SHIMADZU CORPORATION, Kyoto (JP)

(72) Inventor: Kojiro HIGASHIRA, Kyoto-shi (JP)

(73) Assignee: SHIMADZU CORPORATION, Kyoto (JP)

(21) Appl. No.: 19/642,254

(22) Filed: Apr. 8, 2026

(30) Foreign Application Priority Data
Apr. 15, 2025 (JP) 2025-066958

(51) Int. Cl. F16H 25/24; G01N 3/34; F16H 25/20

(52) U.S. Cl. CPC F16H 25/24; G01N 3/34; F16H 2025/2031; F16H 2025/2075

(57) ABSTRACT

An actuator has: a housing 150 having a first side wall 151 and a second side wall 152 facing each other; a screw shaft 131 arranged in the housing and extending in a direction orthogonal to the first side wall; a motor 120 for rotating the screw shaft around an axis thereof; a nut 132 screwed onto the screw shaft and moving along the screw shaft in accordance with rotation of the screw shaft; a piston 110 inserted through a through-hole 156 provided in the first side wall; a rod 140 having a total cross-sectional area equal to that of the piston and inserted through a through-hole 155 provided in the second side wall; oil 500 filling the inside of the housing; and oil seals 191, 192 provided on at least one of between the first side wall and the piston and between the second side wall and the rod.

### TECHNICAL FIELD

The present invention relates to an endurance testing apparatus.

### BACKGROUND ART

An endurance testing apparatus generally includes an actuator including a piston, and the durability of a test piece is tested by causing the piston to reciprocate to apply a load to the test piece. The actuator includes, in addition to the piston, a motor and a ball screw for converting the rotation of the motor into the reciprocating motion of the piston. The ball screw includes a screw shaft and a nut screwed onto the screw shaft. The screw shaft is connected to a rotating shaft of the motor via a connecting shaft, and the nut is connected to a proximal end of the piston.

### Citation List

### Patent Literature

Patent Literature 1: JP 2018-040751 A ([0022])

### SUMMARY OF INVENTION

### Technical Problem

In the endurance testing apparatus equipped with the motor-driven actuator as described above, when attempting to drive the piston at high speed, frictional heat is generated by sliding between the nut of the ball screw and the screw shaft, and there is a risk that the periphery of the ball screw becomes hot and reaches the working limit temperature of various components. Therefore, in a conventional endurance testing apparatus equipped with a motor-driven actuator, there have been cases where the driving speed cannot be increased to the level required by the user.

As a measure against this problem, Patent Literature 1 proposes accommodating the ball screw in a housing, storing oil in a housing internal space which is a space surrounded by the housing, and dissipating frictional heat generated in the ball screw by the oil. The housing is provided with a hole through which the piston is inserted and a hole through which the connecting shaft is inserted, and further, in order to prevent oil from leaking out of the housing from these holes, oil seals are provided between the piston and the housing and between the connecting shaft and the housing, respectively.

However, in the actuator described in Patent Literature 1, since the volume of the space surrounded by the inner surface of the housing and the outer surface of the piston changes due to the reciprocating motion of the piston, oil could only be stored up to about 80% of the maximum capacity of the housing. Therefore, depending on the posture of the actuator during use and the position of each oil seal in the housing, the oil seal between the piston and the housing or the oil seal between the connecting shaft and the housing may not be in contact with the oil, and there is a possibility that the oil seal deteriorates due to frictional heat between the piston or the connecting shaft and the oil seal.

The present invention has been made in view of the above points, and an object thereof is to provide an endurance testing apparatus capable of effectively dissipating frictional heat generated in the ball screw and suppressing deterioration of an oil seal.

### Solution to Problem

An endurance testing apparatus according to the present invention made to solve the above problems is an endurance testing apparatus comprising an actuator, wherein the actuator has: a housing having a first side wall provided with a first through-hole, and a second side wall provided with a second through-hole and facing the first side wall; a screw shaft arranged in a housing internal space which is a space surrounded by the housing, and extending in a direction orthogonal to the first side wall; a motor for rotating the screw shaft around an axis thereof; a nut screwed onto the screw shaft and moving along the screw shaft in accordance with rotation of the screw shaft; a piston inserted through the first through-hole and moving by the same movement amount as the nut in a direction parallel to the axis in accordance with movement of the nut; a rod inserted through the second through-hole and moving by the same movement amount as the nut in a direction parallel to the axis in accordance with movement of the nut; oil filling the housing internal space; and an oil seal provided on at least one of between the first side wall and the piston and between the second side wall and the rod, wherein a total cross-sectional area in a plane perpendicular to the axial direction of a portion of the piston that passes through the first through-hole in accordance with movement of the piston is equal to a total cross-sectional area in a plane perpendicular to the axial direction of a portion of the rod that passes through the second through-hole in accordance with movement of the rod.

### Advantageous Effects of Invention

According to the above configuration, since the volume change of the housing internal space due to the movement of the piston is canceled out by the volume change of the housing internal space due to the movement of the rod, it becomes possible to fill the housing internal space with oil. Therefore, according to the endurance testing apparatus of the present invention, frictional heat generated in the ball screw (the screw shaft and the nut) can be effectively dissipated by the oil, and deterioration of the oil seal can be suppressed.

### BRIEF DESCRIPTION OF DRAWINGS

FIG. 1 is a schematic configuration diagram of an endurance testing apparatus according to an embodiment of the present invention.

FIG. 2 is a schematic diagram showing a state in which a piston is at a reference position and a state in which the piston protrudes outside a housing from the reference position in the actuator of the endurance testing apparatus.

FIG. 3 is a schematic configuration diagram of an endurance testing apparatus according to another embodiment of the present invention.

### DESCRIPTION OF EMBODIMENTS

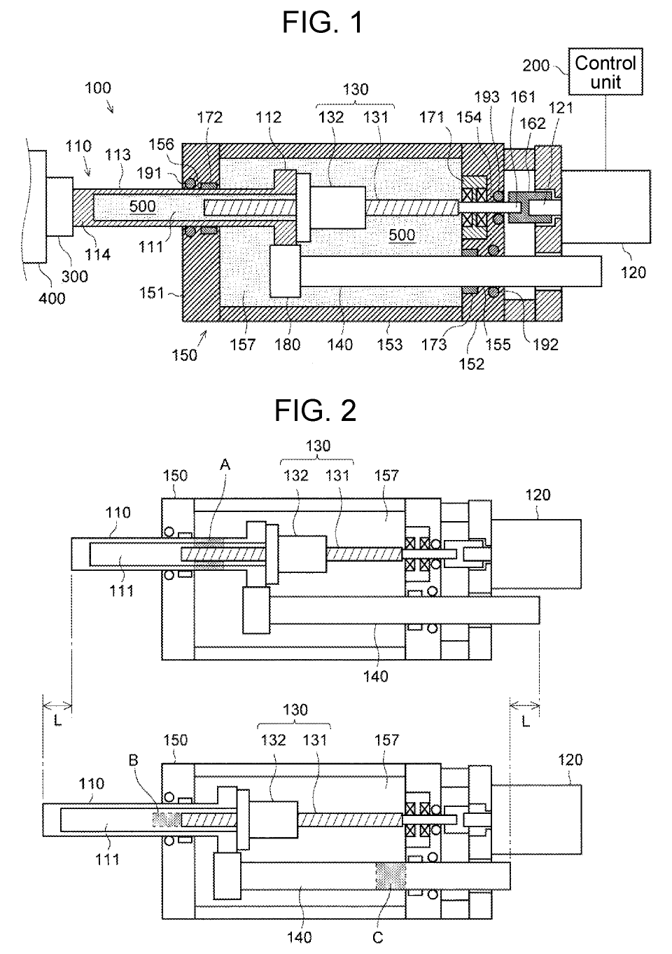

Hereinafter, modes for carrying out the present invention will be described with reference to the drawings. FIG. 1 is a schematic configuration diagram of an endurance testing apparatus according to the present embodiment. In the figure, some components are shown in cross-section for convenience.

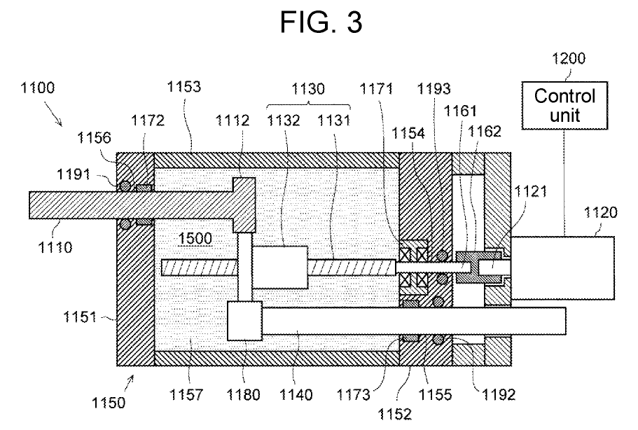

The endurance testing apparatus according to the present embodiment includes an actuator 100 and a control unit 200 that controls the actuator 100. In this endurance testing apparatus, a piston 110 of the actuator 100 reciprocates in the left-right direction in the figure under the control of the control unit 200, and this piston 110 repeatedly applies a load to a test piece 400 via a load cell (load transducer) 300, whereby an endurance test of the test piece 400 is performed. In the following description, for convenience of explanation, the right side in FIG. 1 (and FIGS. 2 and 3 described later) is defined as right, and the upper side is defined as up to define up, down, left, and right. However, the usage mode of the actuator 100 according to the present embodiment is not limited to that shown in the figure; for example, the actuator 100 may be used in a vertical orientation (that is, a state in which the tip of the piston 110 is directed upward or downward along a substantially vertical direction).

The actuator 100 includes, in addition to the piston 110, a motor 120, a ball screw 130, a rod 140, and a housing 150. The housing 150 accommodates the ball screw 130, a proximal end (right end in the figure) side of the piston 110, and a distal end (left end in the figure) side of the rod 140.

The housing 150 includes a square cylindrical or cylindrical tubular member 153, a first end face member 151 (corresponding to the first side wall in the present invention) closing one end face of the tubular member 153, and a second end face member 152 (corresponding to the second side wall in the present invention) closing the other end face of the tubular member 153. The first end face member 151 is provided with a piston insertion hole 156 (corresponding to the first through-hole in the present invention) for inserting the piston 110. Further, the second end face member 152 is provided with a connecting shaft insertion hole 154 for inserting a connecting shaft 161 described later, and a rod insertion hole 155 (corresponding to the second through-hole in the present invention) for inserting the rod 140.

The ball screw 130 includes a screw shaft 131 extending parallel to the axial direction of the tubular member 153, and a nut 132 screwed onto the screw shaft 131. The ball screw 130 may be one provided with a ball retainer or one not provided with a ball retainer. A connecting shaft 161 extending in the axial direction of the screw shaft 131 is connected to a proximal end (right end in the figure) of the screw shaft 131. The connecting shaft 161 is inserted into the connecting shaft insertion hole 154 and is rotatably supported around the axis of the screw shaft 131 by a connecting shaft bearing 171 which is a bearing disposed at a position surrounding the connecting shaft insertion hole 154 of the second end face member 152. The connecting shaft bearing 171 may consist of, for example, a ball bearing, but is not limited thereto.

The piston 110 has a cylindrical shape with a closed distal end side and an open proximal end (that is, the distal end side corresponds to the closed end in the present invention, and the proximal end side corresponds to the open end in the present invention). The piston 110 includes a cylindrical tubular portion 113 and an end face portion 114 closing the end face on the distal end side of the tubular portion 113. The tip (left end in the figure) of the screw shaft 131 of the ball screw 130 is inserted from the opening on the proximal end side of the piston 110 into a piston internal space 111 which is a space surrounded by the tubular portion 113 and the end face portion 114 of the piston 110. A flange 112 is provided on the proximal end side of the piston 110, and the flange 112 is connected to the nut 132 of the ball screw 130 by screwing or the like. The piston 110 is inserted into the piston insertion hole 156 and is slidably supported by a piston bearing 172 which is a bearing disposed at a position surrounding the piston insertion hole 156 of the first end face member 151.

The flange 112 of the piston 110 is further connected to the distal end of the rod 140 via a connecting member 180. The rod 140 is a rod-shaped member extending parallel to the screw shaft 131 of the ball screw 130. The rod 140 is inserted into the rod insertion hole 155 and is slidably supported by a rod bearing 173 which is a bearing disposed at a position surrounding the rod insertion hole 155 of the second end face member 152. This rod 140 plays a role of regulating the rotation of the nut 132 and the piston 110 around the axis of the screw shaft 131. Note that the rod bearing 173 and the above-mentioned piston bearing 172 can be made of, for example, wear rings, but are not limited thereto.

A housing internal space 157 which is a space surrounded by the housing 150, and the above-mentioned piston internal space 111 are filled with oil 500. Note that the housing internal space 157 and the piston internal space 111 are fluidly connected so that the oil 500 can freely flow back and forth. Any oil may be used as the oil 500, but oils generally used as lubricating oils, for example, mineral oils, hydrocarbon synthetic oils, non-hydrocarbon synthetic oils, vegetable oils, or the like, which are liquid at room temperature, can be suitably used. A first oil seal 191, a second oil seal 192, and a third oil seal 193 are provided between the first end face member 151 and the piston 110, between the second end face member 152 and the rod 140, and between the second end face member 152 and the connecting shaft 161, respectively, for preventing the oil 500 from leaking out of the housing 150.

As the motor 120, for example, an AC servo motor can be suitably used, but it is not limited thereto. The rotating shaft 121 of the motor 120 and the above-mentioned connecting shaft 161 are connected to each other via a coupling 162 outside the housing 150. Thereby, the screw shaft 131 of the ball screw 130 can be rotated by the motor 120, and in accordance with the rotation, the nut 132 and the piston 110 and rod 140 connected thereto can be reciprocated in a direction parallel to the axis of the screw shaft 131.

In the actuator 100 according to the present embodiment, the total cross-sectional area of the piston 110 and the total cross-sectional area of the rod 140 are equal. Here, the total cross-sectional area of the piston 110 means the total cross-sectional area of a portion of the piston 110 passing through the piston insertion hole 156 in accordance with the reciprocating motion, in a plane perpendicular to the axial direction of the screw shaft 131 (that is, the area of a region surrounded by the outer periphery of the piston 110 in the plane). Further, the total cross-sectional area of the rod 140 means the total cross-sectional area of a portion of the rod 140 passing through the rod insertion hole 155 in accordance with the reciprocating motion, in a plane perpendicular to the axial direction (that is, the area of a region surrounded by the outer periphery of the rod 140 in the plane).

As described above, in the actuator 100 according to the present embodiment, the total cross-sectional area of the piston 110 and the total cross-sectional area of the rod 140 are equal to each other, and further, a part of the piston 110 and a part of the rod 140 are respectively located in the housing 150, and the piston 110 and the rod 140 are configured to move by the same distance in the same direction in accordance with the rotation of the screw shaft 131 by the motor 120. With such a configuration, in the actuator 100 according to the present embodiment, when the piston 110 is reciprocated, the volume of a space capable of accommodating the oil 500 inside the actuator 100 (hereinafter referred to as actuator internal space), that is, the sum of the volume of the housing internal space 157 and the volume of the piston internal space 111 does not change. Hereinafter, this point will be described in detail with reference to the schematic diagram of FIG. 2.

In the actuator 100 according to the present embodiment, it is assumed that the piston 110 moves to the left by a distance L from the position shown in the upper part of FIG. 2 and reaches the position shown in the lower part of FIG. 2. At this time, since the region indicated by symbol A in the upper part of FIG. 2 (hereinafter referred to as region A) moves from the housing internal space 157 to the outside of the housing 150 in accordance with the movement of the piston 110, the housing internal space 157 increases by the volume of the region A. Further, at this time, since the piston 110 moves relative to the screw shaft 131, the piston internal space 111 increases by the volume of the region indicated by symbol B in the lower part of FIG. 2 (hereinafter referred to as region B). Here, the sum of the cross-sectional area of the region A in a plane perpendicular to the axial direction of the screw shaft 131 (that is, the area obtained by subtracting the area of the region surrounded by the outer periphery of the screw shaft 131 in the plane from the area of the region surrounded by the outer periphery of the piston 110 in the plane) and the cross-sectional area of the region B (that is, the area of the region surrounded by the outer periphery of the screw shaft 131 in the plane perpendicular to the axial direction) is equal to the total cross-sectional area of the piston 110 in the plane, and the lengths (that is, dimensions in the left-right direction) of the region A and the region B are equal to the movement distance L of the piston 110. Therefore, the change amount V_{P} of the volume of the actuator internal space caused by the movement of the piston 110 as described above is V_{P} = (total cross-sectional area of piston) × L. On the other hand, in accordance with the movement of the piston 110 as described above, the rod 140 also moves to the left by the distance L. At this time, since the region indicated by symbol C in the lower part of FIG. 2 (hereinafter referred to as region C) moves from the outside of the housing 150 into the housing internal space 157, the housing internal space 157 becomes narrower by the volume of the region C. That is, the change amount V_{R} of the volume of the actuator internal space caused by the movement of the rod 140 is V_{R} = − (total cross-sectional area of rod) × L. Therefore, the sum of the change amount V_{P} of the volume of the actuator internal space caused by the movement of the piston 110 and the change amount V_{R} of the volume of the actuator internal space caused by the movement of the rod 140 becomes V_{P} + V_{R} = (total cross-sectional area of piston - total cross-sectional area of rod) × L, and since the total cross-sectional area of the piston 110 and the total cross-sectional area of the rod 140 are equal, V_{P} + V_{R} = 0.

Thus, in the actuator 100 according to the present embodiment, the volume change of the actuator internal space due to the reciprocating motion of the piston 110 is canceled out by the volume change of the actuator internal space due to the reciprocating motion of the rod. Therefore, since the volume of the space in which the oil 500 is accommodated does not change even if the piston 110 is reciprocated, the actuator internal space can be completely filled with the oil 500. As a result, regardless of the posture in which the actuator 100 is used, since all of the first oil seal 191, the second oil seal 192, and the third oil seal 193 can be maintained in a state of being in contact with the oil 500, deterioration of the first oil seal 191, the second oil seal 192, or the third oil seal 193 due to sliding with the piston 110, the rod 140, or the connecting shaft 161 can be suppressed.

Although the modes for carrying out the present invention have been described above with reference to specific examples, the present invention is not limited to the above embodiments, and modifications are permitted as appropriate within the scope of the gist of the present invention.

For example, in the above embodiment, the distal end portion of the rod 140 is connected to the proximal end portion of the piston 110, but the present invention is not limited thereto, and the distal end portion of the rod 140 may be connected to the nut 132, or may be connected to both the piston 110 and the nut 132.

Further, in the above embodiment, the actuator 100 is configured to be provided with only one rod 140, but the present invention is not limited thereto, and a configuration in which a plurality of rods 140 are provided may be adopted. In that case, all of the plurality of rods 140 are made to move by the same movement amount in the same direction in accordance with the movement of the nut 132, and the sum of the total cross-sectional areas of the plurality of rods 140 is made to be equal to the total cross-sectional area of the piston 110. Further, the second end face member 152 is provided with the rod insertion hole 155, the rod bearing 173, and the second oil seal 192 at positions corresponding to each of the plurality of rods 140.

Further, in the above embodiment, the piston 110 has a hollow structure and the tip of the screw shaft 131 is inserted into the inside thereof, but the present invention is not limited thereto, and the piston 110 may have a solid structure. An embodiment of the endurance testing apparatus according to the present invention in this case is shown in FIG. 3. In the figure, components that are the same as or correspond to those shown in FIG. 1 are denoted by reference numerals having the same last three digits, and the description thereof is omitted as appropriate. In the present embodiment, a piston 1110 has a solid structure, and a peripheral surface of a flange 1112 provided on the proximal end side thereof and a peripheral surface of a nut 1132 are connected to each other. Also in the present embodiment, the total cross-sectional area of the piston 1110 and the total cross-sectional area of a rod 1140 are equal to each other, and since the volume of a space capable of accommodating oil 1500 inside an actuator 1100 (here, the volume of a housing internal space 1157) does not change even if the piston 1110 is reciprocated, the space can be completely filled with the oil 1500.

[Aspects] It will be apparent to those skilled in the art that the exemplary embodiments described above are specific examples of the following aspects.

(Item 1) An endurance testing apparatus according to one aspect of the present invention is an endurance testing apparatus comprising an actuator, wherein the actuator has: a housing having a first side wall provided with a first through-hole, and a second side wall provided with a second through-hole and facing the first side wall; a screw shaft arranged in a housing internal space which is a space surrounded by the housing, and extending in a direction orthogonal to the first side wall; a motor for rotating the screw shaft around an axis thereof; a nut screwed onto the screw shaft and moving along the screw shaft in accordance with rotation of the screw shaft; a piston inserted through the first through-hole and moving by the same movement amount as the nut in a direction parallel to the axis in accordance with movement of the nut; a rod inserted through the second through-hole and moving by the same movement amount as the nut in a direction parallel to the axis in accordance with movement of the nut; oil filling the housing internal space; and an oil seal provided on at least one of between the first side wall and the piston and between the second side wall and the rod, wherein a total cross-sectional area in a plane perpendicular to the axial direction of a portion of the piston that passes through the first through-hole in accordance with movement of the piston is equal to a total cross-sectional area in a plane perpendicular to the axial direction of a portion of the rod that passes through the second through-hole in accordance with movement of the rod.

(Item 2) The endurance testing apparatus according to Item 2 is the endurance testing apparatus according to Item 1, wherein the rod regulates rotation of the nut around the axis.

(Item 3) The endurance testing apparatus according to Item 3 is the endurance testing apparatus according to Item 1 or 2, wherein the piston includes a cylindrical portion, an open end, and a closed end, and has a configuration in which a piston internal space is defined by the cylindrical portion, the open end, and the closed end, the open end is located in the housing internal space, one end of the screw shaft is inserted from the open end into the piston internal space, and the housing internal space and the piston internal space are fluidly connected.

### DESCRIPTION OF REFERENCE NUMERALS

100... Actuator

110... Piston

111... Piston internal space

120... Motor

130... Ball screw

131... Screw shaft

132... Nut

140... Rod

150... Housing

151... First end face member

152... Second end face member

155... Rod insertion hole

156... Piston insertion hole

157... Housing internal space

161... Connecting shaft

191... First oil seal

192... Second oil seal

193... Third oil seal

500... Oil

1. An endurance testing apparatus comprising an actuator, wherein the actuator has: a housing having a first side wall provided with a first through-hole, and a second side wall provided with a second through-hole and facing the first side wall; a screw shaft arranged in a housing internal space which is a space surrounded by the housing, and extending in a direction orthogonal to the first side wall; a motor for rotating the screw shaft around an axis thereof; a nut screwed onto the screw shaft and moving along the screw shaft in accordance with rotation of the screw shaft; a piston inserted through the first through-hole and moving by the same movement amount as the nut in a direction parallel to the axis in accordance with movement of the nut; a rod inserted through the second through-hole and moving by the same movement amount as the nut in a direction parallel to the axis in accordance with movement of the nut; oil filling the housing internal space; and an oil seal provided on at least one of between the first side wall and the piston and between the second side wall and the rod, wherein a total cross-sectional area in a plane perpendicular to the axial direction of a portion of the piston that passes through the first through-hole in accordance with movement of the piston is equal to a total cross-sectional area in a plane perpendicular to the axial direction of a portion of the rod that passes through the second through-hole in accordance with movement of the rod.

2. The endurance testing apparatus according to claim 1, wherein the rod regulates rotation of the nut around the axis.

3. The endurance testing apparatus according to claim 1, wherein the piston includes a cylindrical portion, an open end, and a closed end, and has a configuration in which a piston internal space is defined by the cylindrical portion, the open end, and the closed end, the open end is located in the housing internal space, one end of the screw shaft is inserted from the open end into the piston internal space, and the housing internal space and the piston internal space are fluidly connected.
